(19) United States
(12) Patent Application Publication
(10) Pub. No.: US 2007/0124546 A1
(43) Pub. Date: May 31, 2007

(54) Automatic yielding on lock contention for a multi-threaded processor

(76) Inventors: Anton Blanchard, Marrickville (AU); Paul F. Russell, Queanbeyan (AU)

Correspondence Address: LIEBERMAN & BRANDSDORFER, LLC, 802 STILL CREEK LANE, GAITHERSBURG, MD, 20878, US

(21) Appl. No.: 11/289,235

(22) Filed: Nov. 29, 2005

(51) Int. Cl. G06F 12/14

(52) U.S. Cl. 711/152

(57) ABSTRACT

A method and system are provided for managing processor resources in a multi-threaded processor. When attempting to acquire a lock on resources available in the cache, tests are conducted to determine if there is a lock on the resource as well as a state of the cache associated with the resource. If it is determined that the lock is in use by another thread, the lock requesting thread may spin on the lock. In limited circumstances a high priority may be assigned to the lock holding thread and a low priority may be assigned to the thread spinning on the lock. Processor resources are proportionally assigned to the threads based upon the assigned priorities, thereby allowing the processor to allocate more resources to a thread assigned a high priority and fewer resources to a thread assigned a low priority.

### BACKGROUND OF THE INVENTION

1. Technical Field

This invention relates to mitigating lock contention for multi-threaded processors.

More specifically, the invention relates to allocating priorities among threads and associated processor resources.

2. Description Of The Prior Art

Multiprocessor systems by definition contain multiple processors, also referred to herein as CPUs, that can execute multiple processes or multiple threads within a single process simultaneously, in a manner known as parallel computing. In general, multiprocessor systems execute multiple processes or threads faster than conventional single processor systems, such as personal computers (PCs), that execute programs sequentially. The actual performance advantage is a function of a number of factors, including the degree to which parts of a multithreaded process and/or multiple distinct processes can be executed in parallel and the architecture of the particular multiprocessor system at hand. One critical factor is the cache present in modem multiprocessors. There is one cache per CPU that is shared by all threads running on that same CPU. Once the data are stored in the cache, future use of the data can be made by accessing the cached copy. Accordingly, performance can be optimized by running processes and threads on CPUs whose data is stored in the cache.

Shared memory multiprocessor systems offer a common physical memory address space that all processors can access. Multiple processes therein, or multiple threads within a process, can communicate through shared variables in the shared memory, which allow the processes to read or write to the same memory location in the computer system. Message passing multiprocessor systems, in contrast to shared memory systems, have a distinct memory space for each processor. Accordingly, messages passing through multiprocessor systems require processes to communicate through explicit messages to each other.

In a multi-threaded processor, one or more threads may require exclusive access to some resource at a given time. A memory location is chosen to manage access to that resource. A thread may request a lock on the memory location to obtain exclusive access to a specific resource managed by the memory location. FIG. 1 is a flow chart (10) illustrating a prior art solution for resolving lock contention between two or more threads on a processor for a specific resource managed by a specified memory location. When a thread requires a lock on a resource, the thread loads a lock value from memory with a special “load with reservation” instruction (12). This “reservation” indicates that the memory location should not be altered by another CPU or thread. The memory location contains a lock value indicating whether the lock is available to the thread. An unlocked value is an indication that the lock is available, and a locked value is an indication that the lock is not available. If the value of the memory location indicates that the lock is unavailable, the resource managed at the memory location is temporarily owned by another thread and is not available to the requesting thread. If the memory location indicates that the lock is available, the resource managed at the memory location is not owned by another thread and is available to the requesting thread. In one embodiment, the locked state may be represented by a bit value of “1” and the unlocked state may be represented by a bit value of “0”. However, the bit values may be reversed. In the illustration shown in FIG. 1, a bit value of “1” indicates the resource managed at the memory location is in a locked state and a bit value of “0” indicates the resource managed at the memory location is in an unlocked state. Following step (12), a test (14) is conducted to determine if the resource managed at the memory location is locked. A positive response to the test at step (14) will result in the thread spinning on the lock on the memory location until it attains an unlocked state, i.e. return to step (12), until a response to the test at step (14) is negative. A negative response to the test at step (14) will result in the requesting thread attempting to store a bit into the memory location managing the requested resource with reservation to try to acquire the lock on the resource (16). Thereafter, another test (18) is conducted to determine if the attempt at step (16) was successful. If another thread has altered the memory location containing the lock value since the load with reservation in step (12), the store at (16) will be unsuccessful. Since the cache is shared by two or more threads, it is possible that more than one thread may be attempting to acquire a lock on the memory location at the same time. A positive response to the test at step (18) is an indication that another thread has acquired a lock on the memory location. The thread that was not able to store the bit into the memory location at step (16) will spin on the lock until the memory location attains an unlocked state, i.e. return to step (12). A negative response to the test at step (18) will result in the requesting thread acquiring the lock (20). The process of spinning on the lock enables the waiting thread to attempt to acquire the lock as soon as the lock is available. However, the process of spinning on the lock also slows down the processor supporting the active thread as the act of spinning utilizes processor resources as it requires that the processor manage more than one operation at a time. This is particularly damaging when the active thread possesses the lock as it is in the interest of the spinning thread to yield processor resources to the active thread. Accordingly, the process of spinning on the lock reduces resources of the processor that may otherwise be available to manage a thread that is in possession of a lock on the memory location.

Therefore, there is a need for a solution which efficiently detects whether a lock is possessed by a thread within the same CPU, or by a thread on another CPU, and appropriately yields processor resources.

### SUMMARY OF THE INVENTION

This invention comprises a method and system for managing operation of a multi-threaded processor.

In one aspect of the invention, a method is provided for mitigating overhead on a multi-threaded processor. A cache state of a memory location on a processor is remembered during the course of loading a lock value. If it is determined from the loaded lock value that the cache state is modified or shared, allocation of processor resources are adjusted to a lock holding thread on the processor.

In another aspect of the invention, a computer system is provided with a multi-threaded processor. The system includes a manager adapted to remember a cache state of a memory location on the processor associated with a lock value. If the lock value is either modified or shared, the processor adjusts allocation of resources to a lock holding thread.

In yet another aspect of the invention, an article is provided with a computer readable medium. Instructions in the medium are provided for loading a lock value, and for remembering a cache state of a memory location on a processor when loading the lock value. In addition, instructions in the medium are provided for adjusting allocation of processor resources to a lock holding thread on the processor if it is determined that the cache state is either modified or shared.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating a prior art process of a thread obtaining a lock on cache.

FIG. 2 is a flow chart of a process of a thread obtaining a lock on cache according to the preferred embodiment of this invention, and is suggested for printing on the first page of the issued patent.

FIG. 3 is block diagram of a CPU with a manager to facilitate threaded processing.

### DESCRIPTION OF THE PREFERRED EMBODIMENT

### Overview

Cache stores duplicate values of data stored elsewhere in a computer. In a multi-threaded processor, a lock on a memory location managing cache may be obtained by a first requesting thread. The operation of obtaining the lock involves writing a value into a memory location of the lock, which will cause the lock value to enter the cache for this CPU in an exclusive state. A second thread may also request the same lock. If the lock is not available to a requesting thread, the thread that has been denied the lock may spin on the lock. Determining whether a lock is available involves a requesting thread reading the value from the memory location of the lock. If this thread is on the same CPU, the cache state will not change, but if this thread is on a different CPU, i.e. with a different cache, the cache state for that memory location will change to shared. At the time a thread obtains or tries to obtain a lock, a state of the cache for that memory location is returned to the requesting thread. A priority is assigned to the lock requesting thread in response to the state of the cache. Assignment of priorities reflects resources allocated by the processor to both a lock holding and non-lock holding thread. Allocation of resources enables the processor to focus resources on a lock holding thread while enabling a lock requesting thread to spin on the lock with fewer processor resources allocated thereto.

### Technical Details

Multi-threaded processors support software applications that execute threads in parallel instead of processing threads in a linear fashion, thereby allowing multiple threads to run simultaneously. Cache is usually in one of the following four states: modified, exclusive, shared, or invalid. The modified cache state is indicative that data in the cache is valid and has been modified by a thread. Cache data in a modified cache state is exclusively owned by the thread that modified the cache. From the modified state, the data can be sourced to another thread on the same processor. The shared cache state is indicative that data in the cache is valid and is also present in another processor's cache. The exclusive cache state indicates that the data in the cache line is valid for that thread and is not present in any other processor's cache. The data has been modified, and it is exclusively owned by the thread that has made the modification. The invalid cache state indicates the data in the cache line is invalid to any thread. Both the modified and shared cache states indicate a previous change to the memory location was caused by another thread on the same processor, and hence implies that another thread on the same processor is holding the lock. Data in the modified and shared cache states is valid and non-exclusive to any one thread. Accordingly, the cache state provides an indicator of activity of the processor with respect to the lock.

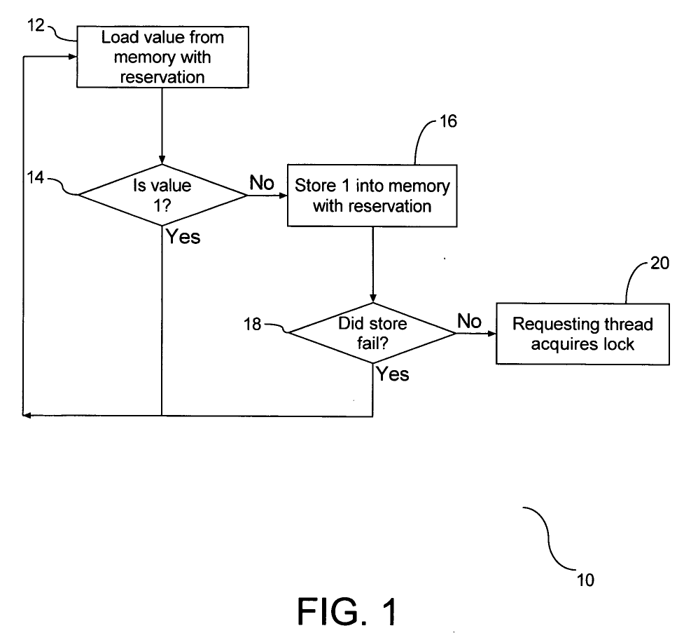

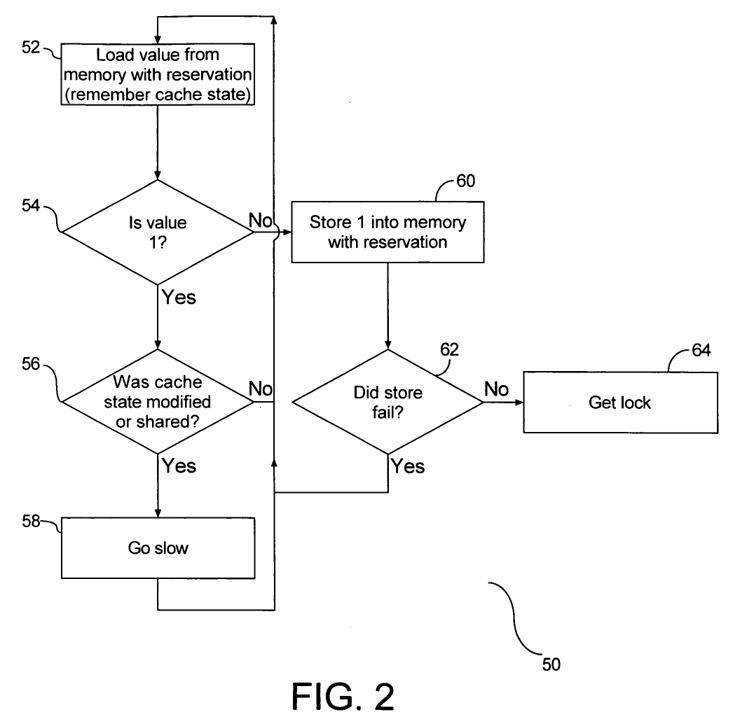

FIG. 2 is a flow chart (50) illustrating a heuristic that enables a thread spinning on a lock to mitigate its load on the processor based upon the cache state. Similar to FIG. 1, a thread requesting a lock on a memory location loads a value from memory remembering the cache state (52). In one embodiment, memory is random access memory (RAM) and lock values reside in RAM. The memory location contains a lock value indicating whether the requested resource associated with the memory location is locked or unlocked. If the value of the memory location indicates the resource is locked, the resource is not available to the requesting thread. Similarly, if the value of the memory location indicates the resource is not locked, the resource may be available to the requesting thread if it can obtain the lock. Since the processor is a multi-threaded processor it may be that more than one thread is attempting to acquire the lock on the same resource at the same time. Therefore, there is no guarantee that the requesting thread can obtain a lock on the requested resource. . In one embodiment, the locked state may be represented by a bit value of “1” and the unlocked state may be represented by a bit value of “0”. However, the bit values may be reversed. In the illustration shown in FIG. 2, a bit value of “1” indicates the memory location is in a locked state and a bit value of “0” indicates the memory location is in an unlocked state. In addition, in one embodiment, the requesting thread accesses a reservation table that stores the state of the cache. The reservation table may be in volatile memory. Following step (52), a test (54) is conducted to determine if the value of the lock bit indicates a locked state. A positive response to the test at step (54), will result in a subsequent test to determine if the state of the cache was either modified or shared (56), as determined from the reservation table at step (52). Both the modified and shared states of the cache are supportive of enabling the processor to reduce allocation of resources to the requesting thread since both of these cache states indicate that the cache line is valid, non-exclusive, and the lock is temporarily being held by another thread. A positive response to the test at step (56) will result in the requesting thread yielding to the lock holding thread (58). Yielding of one thread to another thread reduces the priority level of the requesting thread and increases the priority level of the lock holding thread. In one embodiment, yielding controls the ratio of instructions allocated by the processor to each thread. Such an allocation may include assigning a priority of resources to a lock holding thread. Assignment of priorities to threads enables the processor to proportionally allocate resources. For example, the processor may allocate more resources to a high priority thread and fewer resources to a low priority thread. A negative response to the test at step (56) will result in the requesting thread spinning on the lock, i.e. returning to step (52). Assignment of a lower priority to the spinning thread enables the processor to allocate more resources to the thread in possession of the lock while allowing the non-lock holding thread to continue spinning on the lock while mitigating use of processor resources. If the response to the test at step (54) is negative, this is an indication that there is no lock on the memory location by any one thread. The requesting thread stores a lock state, for example stores a “1” bit, into memory (60). In one embodiment, the bit may be stored in a reservation table in volatile memory. Thereafter, a test (62) is conducted to determine if the store process at step (60) was successful. If another thread has altered the memory location containing the lock value since the request at step (52), the store is unsuccessful. A negative response to the test at step (62) will result in the requesting thread obtaining the lock (64). However, a positive response to the test at step (62) will result in the requesting thread spinning on the lock and returning to step (52). Accordingly, a thread spinning on the lock may yield to a lock holding thread to enable the processor to efficiently allocate resources among threads.

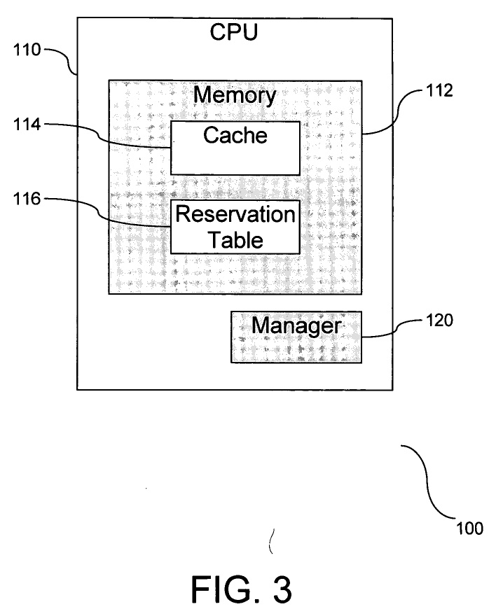

In one embodiment, the multi-threaded computer system may be configured with a manager to facilitate with assignment of processor resources to lock holding and non-lock holding threads. FIG. 3 is a block diagram (100) of a processor (110) with memory (112) having cache (114) and a reservation table (116). The manager (120) may be a hardware element that retains knowledge of a cache state of a thread on a processor that is associated with a lock value. As discussed above, the lock value may be a bit value having a “1” or a “0”. The cache state may be modified, shared, exclusive, or invalid. If the manager ascertains that another thread holds a lock on the cache and the cache state is either modified or shared, the manager communicates with the processor to assign a high priority to the lock holding thread and a low priority to the non-lock holding thread. In addition, the manager communicates with the non-lock holding thread authorization to spin on the lock. In one embodiment, the manager may be a software component stored on a computer-readable medium as it contains data in a machine readable format. With respect to the elements shown in FIG. 3, the manager (120) could be embodied within memory (112). For the purposes of this description, a computer-useable, computer-readable, and machine readable medium or format can be any apparatus that can contain, store, communicate, propagate, or transport the program for use by or in connection with the instruction execution system, apparatus, or device. Accordingly, the cache management tool may be in the form of hardware elements in the computer system or software elements in a computer-readable format or a combination of software and hardware elements.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

### Advantages Over The Prior Art

Priorities are assigned to both lock holding and non-lock holding threads. The assigned priorities enables the non-lock holding thread to spin on the memory location and it enables the lock holding thread to be processed by the processor. At the same time, the processor may allocate more resources to the lock holding thread and fewer resources to the thread spinning on the lock. The allocation of resources enables efficient processing of the lock holding thread while continuing to allow the non-lock holding thread to spin on the memory location.

### Alternative Embodiments

It will be appreciated that, although specific embodiments of the invention have been described herein for purposes of illustration, various modifications may be made without departing from the spirit and scope of the invention. In particular, the names of cache states might be different, or there might be more cache states by which the processor resources may be efficiently reallocated or fewer cache states that may accept yielding of processor resources. Similarly, manager (120) may reside within memory (112) as shown, or it may be relocated to reside within chip logic. Additionally, yielding of processor resources may be allocated enable the processor to devote resources to a lock holding thread up to a ratio of 32:1. Accordingly, the scope of protection of this invention is limited only by the following claims and their equivalents.

We claim:

1. A method for mitigating overhead on a multi-threaded processor, comprising:
remembering a cache state of a memory location on a processor when loading a lock value; and
adjusting allocation of processor resources to a lock holding thread on said processor responsive to said remembered cache state having a value selected from a group consisting of: modified and shared.

2. The method of claim 1, wherein said lock value is loaded from a reservation table.

3. The method of claim 2, wherein said reservation table is stored in volatile memory.

4. The method of claim 1, wherein the step of adjusting allocation of processor resources includes assigning a high priority level to a thread holding said lock.

5. The method of claim 1, wherein the step of adjusting allocation of processor resources includes assigning a low priority level to a non-lock holding thread.

6. A computer system comprising:
a multi-threaded processor;
a manager adapted to remember a cache state of a memory location on said processor associated with a lock value; and
said processor adapted to adjust allocation of resources to a lock holding thread with said cache state having a value selected from a group consisting of: modified and shared.

7. The system of claim 6, wherein said lock value is loaded from a reservation table.

8. The system of claim 7, wherein said reservation table is stored in volatile memory.

9. The system of claim 6, further comprising a priority level of a thread holding said lock adapted to be increased.

10. The system of claim 6, further comprising a priority level of a non-lock holding thread adapted to be decreased.

11. An article comprising:
a computer readable medium;
instructions in said medium for loading a lock value;
instructions in said medium for remembering a cache state of a memory location on a processor when loading said lock value; and
instructions in said medium for adjusting allocation of processor resources to a lock holding thread on said processor responsive to said remembered cache state having a value selected from a group consisting of: modified and shared.

12. The article of claim 11, wherein said lock value is loaded from a reservation table.

13. The article of claim 12, wherein said reservation table is stored in volatile memory.

14. The article of claim 11, wherein the instructions for adjusting allocation of processor resources to another thread on said processor includes increasing a priority level of a thread holding said lock.

15. The article of claim 11, wherein the instructions for adjusting allocation of processor resources to another thread on said processor includes lowering a priority level of a non-lock holding thread.
